(19) United States
(12) Patent Application Publication
(10) Pub. No.: US 2014/0317594 A1
(43) Pub. Date: Oct. 23, 2014

(54) SYSTEM AND METHOD FOR AUTOMATICALLY FORMING HUMAN-MACHINE INTERFACE

(71) Applicant: eBao Tech Corporation, Shanghai (CN)

(72) Inventors: Henry HE, Shanghai (CN); Oliver ZHOU, Shanghai (CN); Wuzhen XIONG, Shanghai (CN); Coral MA, Shanghai (CN)

(21) Appl. No.: 14/227,392

(22) Filed: Mar. 27, 2014

(30) Foreign Application Priority Data
Apr. 22, 2013 (CN) 201310140770.1

(51) Int. Cl. G06F 9/44

(52) U.S. Cl. CPC G06F 8/38
USPC 717/105

(57) ABSTRACT

Method and system for automatically forming a human-machine interface are provided. The method includes: defining, based on contents to be illustrated in the human-machine interface, a model object including at least one model component have a one-to-one mapping relationship with metadata in a database; establishing a model-view corresponding to the defined model object, where the model-view may include at least one model-view element each of which having a mapping relationship with one of the at least one model component; and analyzing the defined model object and the established model-view based on a predetermined syntax rule to form a model object configuration file and a human-machine interface configuration file, where the model object configuration file is adapted to provide mapping between the defined model object and the database, and the human-machine interface configuration file is adapted to illustrate the model object using the corresponding model-view. Workload may be reduced.

### CROSS REFERENCE TO RELATED APPLICATIONS

The present application claims priority to Chinese Patent Application No. 201310140770.1, filed on Apr. 22, 2013 and entitled “SYSTEM AND METHOD FOR AUTOMATICALLY FORMING HUMAN-MACHINE INTERFACE”, the entire disclosure of which is incorporated herein by reference.

### FIELD OF THE DISCLOSURE

The present disclosure generally relates to computer software, and more particularly, to a method and a system for automatically generating a human-machine interface.

### BACKGROUND OF THE DISCLOSURE

Nowadays, Model-View-Controller (MVC) software design pattern has been widely used in various enterprise applications due to its fast deployment and low life cycle cost.

MVC design pattern realizes a separation of designing functional modules and display modules, such that some programmers (such as Java programmers) may focus on developing business logics, while interface programmers (such as HTML and JSP programmers) may focus on expression.

As shown in FIG. 1, in a MVC design pattern, there are defined a model layer “Model”, a view layer “View” and a controller layer “Controller”. The model layer may execute business logic in a system, and represent enterprise data and business rules. The Model layer may process data in a database and provide data for a plurality of views. The view layer may provide interfaces for users, which interfaces may present business data in the model layer and further enable user-machine interaction. The controller layer may communicate between the model layer and the view layer. The controller part may receive a user request and determine which model contained in the model layer to invoke to process the request, and then determine which view of the view layer to be used for illustrating feedback data.

Regarding the view layer, complex human-machine interfaces are required to facilitate mass data input operations which commonly exist in typical enterprise applications. As a result, even with the help of MVC design pattern to develop an enterprise application, developers still have to put a lot of efforts into designing these interfaces. Further, human-machine interfaces developed in such a pattern may have drawbacks like repeated human labor consumption, poor error correction, low reusability, high maintenance cost, and the like.

Therefore, methods for effectively reducing workload for developing view layer under MVC design pattern are needed, such that programmers can be more focus on developing business logics.

### BRIEF SUMMARY OF THE DISCLOSURE

According to one embodiment, a method for automatically forming a human-machine interface is provided. The method may include:

defining a model object based on contents to be illustrated in the human-machine interface, where the model object may include at least one model component have a one-to-one mapping relationship with metadata in a database;

establishing a model-view corresponding to the defined model object, where the model-view may include at least one model-view element each of which having a mapping relationship with one of the at least one model component; and

analyzing the defined model object and the established model-view based on a predetermined syntax rule to form a model object configuration file and a human-machine interface configuration file, where the model object configuration file is adapted to provide mapping between the defined model object and the database, and the human-machine interface configuration file is adapted to illustrate the model object using the corresponding model-view.

In some embodiments, the model-view element may include at least one of a model-view element for displaying, a model-view element for creating, a model-view element for updating, a model-view element for searching, a model-view element for listing and a model-view element for item illustration.

In some embodiments, defining the model object may further include:

defining an association relationship between model components, where an illustration pattern of the human-machine interface for illustrating the defined model object in the human-machine interface corresponds to the defined association relationship, and the association relationship is represented in the human-machine configuration file after analysis.

In some embodiments, the association relationship between model components may include one or more of an aggregation relationship, a composition relationship and a multiplicity relationship.

In some embodiments, the illustration pattern of the human-machine interface may include one or more of link, pull-down list, data table, embedded form and form.

In some embodiments, the method may further include:

defining an operation button corresponding to a particular operation to a model component, where the particular operation corresponds to the model-view element; and

analyzing the operation button and representing, in the human-machine interface configuration file, relationship between the operation button and the model component and the model-view element.

In some embodiments, the particular operation may include one or more of display, create, update, delete and search.

In some embodiments, establishing the model-view corresponding to the defined model object may further include:

describing a property of the model-view element, where an illustration pattern for illustrating the model-view element in the human-machine interface corresponds to the property, and the property is represented in the human-machine interface configuration file after the analysis.

In some embodiments, the property may include one or more of button layout, button grouping, group embedding, button pattern, read-only, data format and event expression format.

In some embodiments, defining the model object and establishing the model-view corresponding to the defined model object are implemented using a natural expression language script.

In some embodiments, the method may further include:

before defining the model object and establishing the model-view corresponding to the defined model object, determining a syntax rule of the natural expression language, where the predetermined syntax rule may include the syntax rule of the natural expression language.

In some embodiments, the human-machine interface configuration file may include at least one kind of JAVA class codes, object relational mapping file and JAVA document.

According to one embodiment, a system for automatically forming a human-machine interface is provided, the system may include:

a model object unit, adapted to define a model object based on contents to be illustrated in the human-machine interface, where the model object may include at least one model component have a one-to-one mapping relationship with metadata in a database;

a model-view unit, adapted to establish a model-view corresponding to the defined model object, where the model-view may include at least one model-view element each of which having a mapping relationship with one of the at least one model component; and

an analysis configuration unit, adapted to analyze the defined model object and the established model-view based on a predetermined syntax rule to form a model object configuration file and a human-machine interface configuration file, where the model object configuration file is adapted to provide mapping between the defined model object and the database, and the human-machine interface configuration file is adapted to illustrate the model object using the corresponding model-view.

In some embodiments, the model-view element may include at least one of a model-view element for displaying, a model-view element for creating, a model-view element for updating, a model-view element for searching, a model-view element for listing and a model-view element for item illustration.

In some embodiments, the model object unit may further include:

an association unit, adapted to define an association relationship between model components, where an illustration pattern of the human-machine interface for illustrating the defined model object in the human-machine interface corresponds to the defined association relationship,

where the analysis configuration unit is further adapted to analyze the association relationship, and the association relationship is represented in the human-machine configuration file after the analysis.

In some embodiments, the system may further include:

an operation button unit, adapted to define an operation button corresponding to a particular operation to a model component, where the particular operation corresponds to the model-view element,

where the analysis configuration unit is further adapted to analyze the operation button and represent, in the human-machine interface configuration file, relationship between the operation button and the model component and the model-view element.

In some embodiments, the model-view unit may further include:

a property describing unit, adapted to describe a property of the model-view element, where an illustration pattern for illustrating the model-view element in the human-machine interface corresponds to the property,

where the analysis configuration unit is further adapted to analyze the property and the property is represented in the human-machine interface configuration file after the analysis.

Embodiments of the present disclosure may have following advantages.

By defining a model object and establishing a corresponding model-view, a configuration file for illustration a view corresponding to the model object may be automatically formed based on analysis. Therefore, the amount of code requiring manually input may be reduced.

A model-view layer is introduced between a model layer and a view layer, such that a relatively high level of coupling between fields in the model layer and the view layer may be replaced by a relatively low level of coupling between the model layer and the model-view layer. Therefore, button universality and expansibility may be increased.

In some embodiments, operation buttons may be provided, such that the model layer and the view layer can be associated through actions. Each kind of the actions may be expressed using a corresponding model-view element. Therefore, the coupling level between the model and the view may be further reduced. Furthermore, difficulties in realizing universal illustration buttons may be reduced, thus universality and usability may be improved.

### BRIEF DESCRIPTION OF THE DRAWINGS

FIG. 1 schematically illustrates a conventional MVC design pattern;

FIG. 2 schematically illustrates a MVC design pattern according to one embodiment of the present disclosure;

FIG. 3 schematically illustrates a flow chart of a process for automatically forming a human-machine interface according to one embodiment of the present disclosure;

FIG. 4 schematically illustrates an example for presenting an aggregation relationship in a human-machine interface according to one embodiment of the present disclosure;

FIG. 5 schematically illustrates another example for presenting an aggregation relationship in a human-machine interface according to one embodiment of the present disclosure;

FIG. 6 schematically illustrates an example for presenting a composition relationship in a human-machine interface according to one embodiment of the present disclosure;

FIG. 7 schematically illustrates an example for presenting a multiplicity relationship in a human-machine interface according to one embodiment of the present disclosure;

FIG. 8 schematically illustrates another example for presenting a multiplicity relationship in a human-machine interface according to one embodiment of the present disclosure;

FIG. 9 schematically illustrates a data flow diagram of another process for automatically forming a human-machine interface according to one embodiment of the present disclosure;

FIG. 10 schematically illustrates a natural expression language script according to one embodiment of the present disclosure;

FIG. 11 schematically illustrates a flow chart of a specific process for implementing analysis and syntax verification steps in the flow chart illustrated in FIG. 9 according to one embodiment of the present disclosure;

FIG. 12 schematically illustrates a model object configuration file according to one embodiment of the present disclosure;

FIG. 13 schematically illustrates a human-machine interface configuration file according to one embodiment of the present disclosure;

FIGS. 14a and 14b schematically illustrate rendered human-machine interfaces according to one embodiment of the present disclosure; and

FIG. 15 schematically illustrates a block diagram of a system for automatically forming a human-machine interface according to one embodiment of the present disclosure.

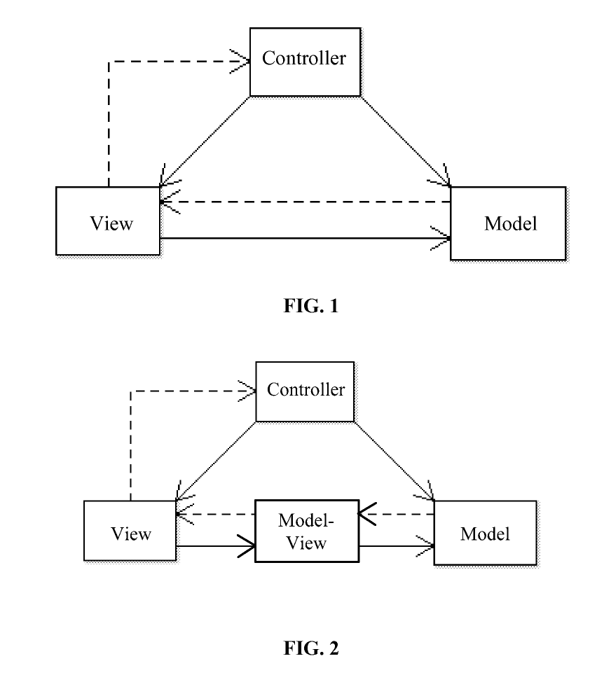

### DETAILED DESCRIPTION OF THE DISCLOSURE

Detail exemplary embodiments will be illustrated to provide thorough understanding of the present disclosure. Nevertheless, the present disclosure could be implemented in embodiments other than those described hereinafter. Those skilled in the art can make any variation and modification without departing from the scope of the disclosure. Therefore, the present disclosure may not be limited by embodiments disclosed hereinafter.

Besides, embodiments of the disclosure will be interpreted in detail in combination with accompanying drawings. It should be noted that the accompanying drawings are merely examples for illustrating embodiments of the disclosure, which should not limit the scope of the present disclosure.

Inventors, after analyzing a large number of cases for developing enterprise applications, found that remarkable labor may be wasted in repeatedly developing human-machine interfaces of enterprise applications using conventional design modes, the reason of which may lie in a high coupling degree between a view layer and a model layer in the conventional modes. Specifically, contents illustrated by the view layer are bound with particular fields in the model layer. As a result, even if different views may illustrate the same contents, repeated binding with field(s) in the model layer are still required, since the same contents are illustrated in different views. For example, a user may require a client record to be presented in a first page and a new client record updated based on adding of a new client to be presented in a second page (such as illustrating a result from an adding operation using an Add button). Although contents illustrated by both the first page and the second page are corresponding to a field containing client name/ID in the model layer, a binding between the view layer and the client name/ID field in the model layer is necessary for both the first page and the second page, since the second page is a new page triggered by the Add button.

In order to improve reusability of resulting interfaces, inventors attempted to reduce the coupling degree between the view layer and the model layer. By analyzing routine works in human-machine interface developing, it could be concluded that human-machine interfaces are normally required to provide several operations, which may be summarized into following six modes:

(1) Providing interface information for displaying a backend model object, which may be referred as Display;

(2) Providing interface information for creating a new model object, which may be referred as Create;

(3) Providing interface information for updating an existing model object, which may be referred as Update;

(4) Providing interface information for searching a model object, which may be referred as Search;

(5) Providing interface information for listing a collection of model objects, which may be referred as List; and

(6) Providing most characteristic item information of a model object, which may be referred as Item.

As described above, the number of operations required to be provided by interfaces is normally limited. Therefore, based on the required different operations, a model-view layer “Model-View” may be introduced into a conventional MVC design pattern, disposed between a view layer and a model layer, as shown in FIG. 2. In some embodiments, model-view elements for generating views for illustrating the model operations listed above may be defined in the model-view layer. In some embodiments, the model-view elements may include elements for generating a DisplayView, a CreateView, an UpdateView, a SearchView, a ListView and an ItemView corresponding to various model objects. By introducing the model-view layer, the conventional field level coupling in the model layer between the view layer and the model layer may be replaced by a coupling between the view layer and the illustrations elements in the model-view layer. Therefore, universality and expansibility may be improved.

In some embodiments, for further reducing the workload of developing the view layer and facilitating programmers focusing on business logics, configuration files of the view layer may be automatically formed using the new introduced model-view layer. In some embodiments, natural expression language (NEL) may be used to express contents in the model layer, model-view layer and the view layer, which is more complied with expression habits. Besides, NEL syntax rules may be defined to implement automatically forming the view layer configuration files.

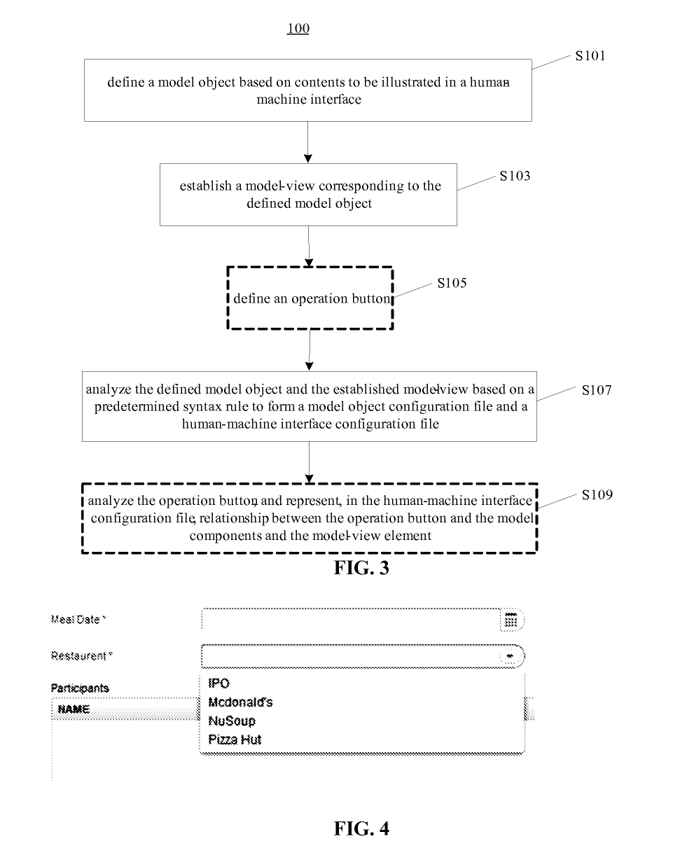

A method for automatically forming a human-machine interface is provided in the present disclosure. FIG. 3 schematically illustrates a flow chart of a process 100 for automatically forming a human-machine interface according to one embodiment of the present disclosure. As shown in FIG. 3, the process 100 may include S101, S103, S105, S107 and S109.

In S101: define a model object based on contents to be illustrated in a human-machine interface.

Specifically, in some embodiments, defining the model object may include defining model components of the model object. The model components may be mapped to metadata in a database, respectively. Those skilled in the art could understand that, based on the mappings, the model layer may implement certain processing to the corresponding metadata in the database and then present the metadata in a view of the view layer.

Further, in some embodiments, defining the model object may further include defining association relationship between the model components. Different illustration patterns may be used in the human-machine interface correspondingly to different association relations. It should be noted that the association relationship between the model components may include association relationship between model components in a same model object and association relationship between model components in different model objects.

Specifically, in some embodiments, the association relationship between the model components may include at least one selected from aggregation relationship, composition relationship and multiplicity relationship. Illustration patterns corresponding to the association relationship may include at least one selected from link, pull-down list, data table, embedded form and form.

Among the association relations, aggregation relationship is a relatively weak association relationship. Model components having association relationship between each other have independent life cycles. Therefore, when a user defines an aggregation relationship for a model component A and a model component B, normally the particular contents of the model component B may be obtained from a link or a pull-down list of the model component A in a human-machine interface.

Hereunder gives some example for illustrating defining association relationships. It should be noted that, in the present disclosure, names of model objects are not necessarily the same as characters illustrated in corresponding interfaces for presenting the model objects.

FIG. 4 schematically illustrates an exemplary embodiment of a human-machine interface in which an aggregation relationship between model components is illustrated using a pull-down list. FIG. 4 schematically illustrates a first interface corresponding to a model object MealRecord. The model object MealRecord includes a model component Restaurant which has an aggregation relationship with a model component recordRestaurant of another model object Restaurent. As shown in FIG. 4, in the first interface, the model component Restaurent provides a pull-down list in its value column. Records of the model component recordRestaurent in a database may be illustrated by clicking the pull-down list. The user may select one recordRestaurent from the records, such that an aggregation relationship may be established between the model component Restaurent and the model component recordRestaurent.

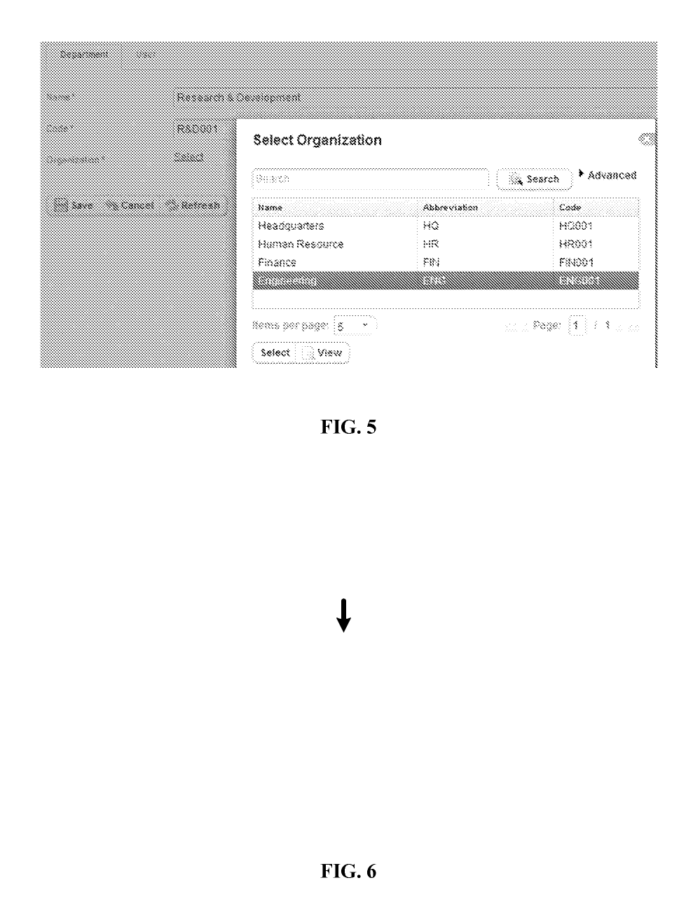

FIG. 5 schematically illustrates another exemplary embodiment of a human-machine interface in which an aggregation relationship between model components is illustrated using a link. FIG. 5 schematically illustrates a second interface corresponding to a model object Department and a third interface corresponding to a model object Select Organization. The model object Department includes a model component Organization having an aggregation relationship with a model component Name of the model object Select Organization. As shown in FIG. 5, in the second interface, the model component Organization provides a link Select in its value column. The third interface may appear if the link Select is clicked. When the third interface is under operation, the user may only be able to conduct operations in the third interface, while the second interface may be grayed or hidden. The third interface may present records of model components Name, Abbreviation and Code of the model object Organization. The user may select the model component Name, such that an aggregation relationship may be established between the model component Organization in the second interface and the model component Name in the third interface.

Among the association relationship listed above, composition relationship is a relatively strong association relationship. A life cycle of a composed model component may depend on a life cycle of its parent model component. When a parent model component A is deleted, a model component B having composition relationship with it may also be deleted. Therefore, if the user defines a composition relationship between the model component A and the model component B, normally the particular contents of the composition relationship may be represented using an embedded form in a human-machine interface.

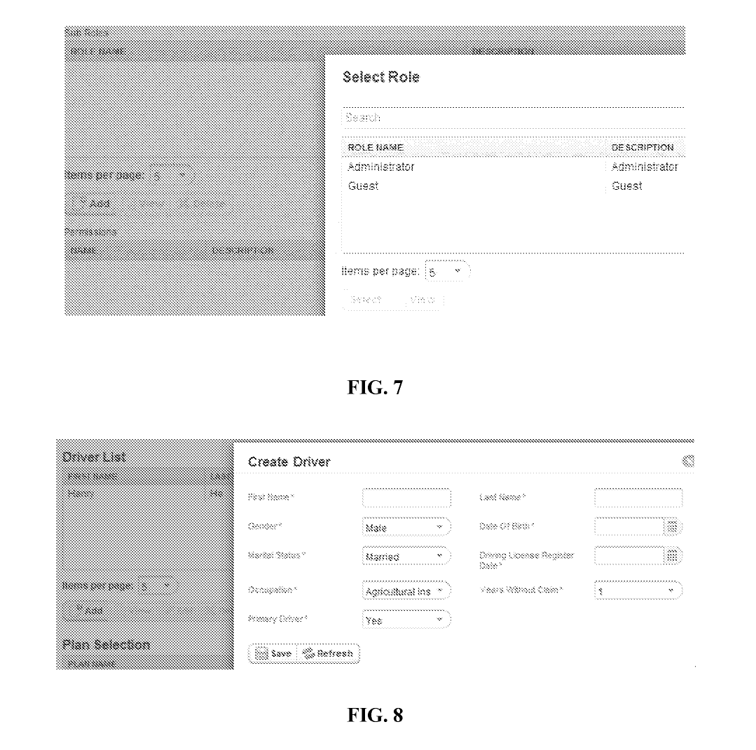

FIG. 6 schematically illustrates an exemplary embodiment of a human-machine interface in which a composition relationship between model components is illustrated in using an embedded form. FIG. 6 schematically illustrates a fourth interface (the interface above an arrow in FIG. 6) corresponding to a model object MealRecord and a fifth interface (the upper interface below the arrow in FIG. 6) corresponding to a model object ROLE. The model object MealRecord includes a model component PARTICIPANTS having a composition relationship with a model component Name of the model object ROLE. As shown in FIG. 6, the model component PARTICIPANTS provides a button “ . . . ” in its value column. An embedded form (i.e., the fifth interface) is illustrated by clicking the button “ . . . ”. Records of the model object ROLE in the database may be specifically illustrated in the embedded form. The user may select the model component NAME from the records, such that a composition relationship may be established between the model component PARTICIPANTS and the model component NAME.

Among the association relationship listed above, multiplicity relationship represents a one-to-many association relationship of model components, which may be one-to-many aggregation relationship or one-to-many composition relationship. If the user defines a one-to-many aggregation relationship between the model components, normally the one-to-many aggregation relationship may be represented using a data table in a human-machine interface. If the user defines a one-to-many composition relationship between the model components, normally the one-to-many composition relationship may be represented using a form in a human-machine interface.

FIG. 7 schematically illustrates an exemplary embodiment of a human-machine interface in which a one-to-many aggregation relationship among model components is illustrated using a data table. FIG. 7 schematically illustrates a sixth interface corresponding to a model object Sub Roles and a seventh interface corresponding to a model object Select Role. The model object Sub Roles includes a model component ROLE NAME having a one-to-many aggregation relationship with a model component ROLE Name of the model object Select Role. As shown in FIG. 7, an Add button is provided in the sixth interface. The seventh interface for adding model component Role Name may appear if the Add button is clicked. When the seventh interface is under operation, the user may only be able to conduct operations in the seventh interface, while the sixth interface may be grayed or hidden. The seventh interface may present records of model components in the model object Select Role. The user may select multiple model components in the model component ROLE NAME in the seventh, such that a one-to-many aggregation relationship may be established between the model component ROLE NAME of the model object Sub Roles and the model component ROLE NAME of the model object Select Role. For example, the user may select two model components Administrator and Guest, such that a one-to-many aggregation relationship may be established between the model component ROLE NAME of the model object Sub Roles and the model component ROLE NAME of the model object Select Role.

FIG. 8 schematically illustrates an exemplary embodiment of a human-machine interface in which a one-to-many composition relationship among model components is illustrated using a pop-up window form. FIG. 8 schematically illustrates an eighth interface corresponding to a model object Driver List and a ninth interface corresponding to a model object Create Driver. The model object Driver List includes a model component FIRST NAME having a one-to-many composition relationship with model components of the model object Create Driver. As shown in FIG. 8, an Add button is provided in the eighth interface. The ninth interface for adding values for the model component FIRST NAME may appear if the Add button is clicked. When the ninth interface is under operation, the user may only be able to conduct operations in the ninth interface, while the eighth interface may be grayed or hidden. The ninth interface may present various model components of the model object Create Driver using a pop-up window form. The user may input specific values of the various model components of the model object Create Driver, such that a one-to-many composition relationship may be established between the model component FIRST NAME of the model object Driver List and the model components of the model object Create Driver.

Referring to FIG. 3, in S103: establish a model-view corresponding to the defined model object.

In some embodiments, establishing a model-view corresponding to the defined model object may include defining at least one model-view element of the model-view and establishing mapping relationships between the model-view elements and the model components of the defined model object. The model-view may at least have one model-view element each of which is corresponding to one of the at least one model component. Such that, mapping may be established between the model-view(s) and the model component(s).

In some embodiments, the model-view elements may be used for generating at least one kind of view selected from the DisplayView, the CreateView, the UpdateView, the SearchView, the ListView and the ItemView.

Specifically, the DisplayView may be adapted to express how to provide, for the user, interface information in the model object.

The CreateView may be adapted to express how to provide, for the user, interface information for creating a new model object.

The UpdateView may be adapted to express how to provide, for the user, interface information for updating an existing model object.

The SearchView may be adapted to express how to provide, for the user, interface information for searching a model object.

The ListView may be adapted to express how to provide, for the user, interface information for listing a collection of model objects.

The ItemView may be adapted to express how to provide, for the user, most characteristic item information of a model object.

In some embodiments, establishing a model-view corresponding to the defined model object may further include: expressing at least one property of the model-view element. The at least one property may determine visual effects of the model-view element presented in a human-machine interface. In some embodiments, the property may include one or more of button layout, button grouping, group embedding, button pattern, read-only, data format and event expression.

Specifically, in some embodiments, the button layout may include elements for organizing and arranging various model-views in a human-machine interface, such as column number, width, line feed, etc.

In some embodiments, the button grouping may provide container control (such as defining a frame) in a human-machine interface. The button layout may be arranged with in the container.

In some embodiments, the group embedding may define that not only buttons can be arranged in a container, but also another container can be arranged in the former container.

In some embodiments, the button pattern may include illustration patterns for illustrating various model-view elements, such as pull-down list, cascade list, etc.

In some embodiments, the data format may define illustrating various model-view elements in a human-machine interface with a particular data format. For example, a mapping exists between a model-view element and a model component regarding date, then a data format for illustrating the model component in a human-machine interface may be defined as “mm-dd-yy”, or the like.

In some embodiments, the event expression may provide interactions in module level, such as modifying event, loading event, etc.

Referring to FIG. 3, in S107: analyze the defined model object and the established model-view based on a predetermined syntax rule to form a model object configuration file and a human-machine interface configuration file. The model object configuration file may be adapted to provide mapping between the model object and a database, and the human-machine interface configuration file may be adapted to illustrate the model object using the corresponding model-view. Specifically, in some embodiments, the human-machine interface configuration file may include at least one kind of JAVA class codes, object relational mapping files and JAVA documents.

Those skilled in the art could understand that both the model object configuration file and the human-machine interface configuration file may be static files. On the basis that mapping is already established between the model-view element and the model components, the above described static files are able to be automatically generated based on syntax analysis.

It should be noted that, the configuration files are configured to be automatically formed to reduce workload for developing the view layer. However, in order to support specific illustration requirement, manually writing some parts of the codes may be support in some embodiments. Therefore, the user can have more options and better experience.

It should be noted that, if the user defines the association relationship between the model components and/or expresses properties of the model-view element, the association relationship and the model-view element will be represented in the human-machine interface configuration file formed after the analysis.

Those skilled in the art could understand that, in some embodiments, defining the model object and establishing the model-view may be implemented through script edit. Therefore, in some embodiments, syntax rules and meanings may be determined before the above described processing is implemented. It should be noted that determining the syntax rules and meanings is not illustrated in FIG. 3. In some embodiment, natural expression language (NEL) may be used to define the model object and establish the model-view. Accordingly, some embodiments may include: determining a syntax rule of the natural expression language before defining the model object, establishing the model-view and analyzing the defined model object and the established model-view. It should be noted that determining the syntax rule of the natural expression language is not illustrated in FIG. 3.

In some embodiments, controller part developing may be implemented to provide operation buttons in the human-machine interface to be formed, such that the user can implement particular operations to particular model components by triggering the operation buttons. In some embodiments, referring to FIG. 3, before S107, the process 100 may further include S105: define an operation button. The operation button corresponds to particular operation(s) to the model components. The particular operation(s) may include at least one of display, create, update, delete and search. Further, the particular operation(s) may be corresponding to the at least one model-view element. For example, the display operation may correspond to the DisplayView, the search operation may correspond to the SearchView, and the like. It should be noted that, S105 is optional.

In some embodiments, after S107, the process 100 may include S109: analyze the operation button, and represent, in the human-machine interface configuration file, relationship between the operation button and the model components and the model-view element.

Thereafter, the human-machine interface configuration file may be loaded in a user terminal using a rendering engine, such that a human-machine interface can be illustrated at the user terminal. By clicking the operation button provided in the human-machine interface, various operations may be implemented to data which are in the database and corresponding to the model object. Operation results may be illustrated at the user terminal in a new human-machine interface or an update of the formed human-machine interface.

To clarify the present disclosure, an exemplary embodiment will be illustrated hereinafter, in which a particular human-machine interface is provided, illustrating automatic settlement result for equally shared meal cost.

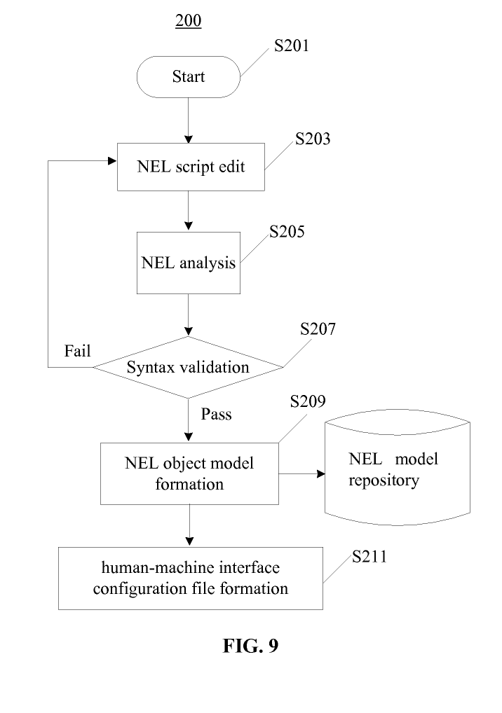

FIG. 9 schematically illustrates a data flow diagram of a process 200 for forming the particular human-machine interface.

Referring to FIG. 9, in S201: start. The process 200 starts.

Thereafter, in S203: NEL script edit. A natural expression language (NEL) script is edited to define a model object and establish a model-view.

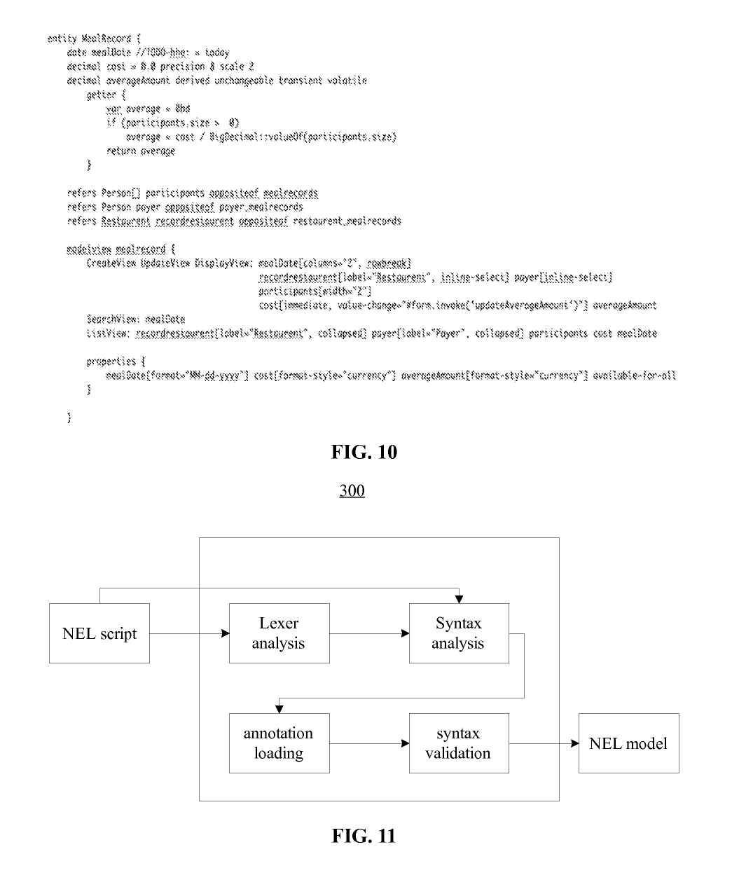

FIG. 10 schematically illustrates an example of a NEL script used in the process 200.

As shown in FIG. 10, a model object entityMealRecord is defined, including: a model component mealDate, a model component cost, a model component averageAmount, a model component participants, a model component payer and a model component recordrestaurent. The model component participants has a one-to-many aggregation relationship with a model component participants in another model object mealrecords. The model component payer has a one-to-one aggregation relationship with a model component payer in another model object payer_mealrecords. The model component restaurent has a one-to-one aggregation relationship with a model component recordrestaurent of another model object restaurent_mealrecords.

Referring to FIG. 10, a model-view mealrecord corresponding to the model object entity MealRecord is established. The model-view includes elements for generating following views: a CreateView, an UpdateView, a DisplayView, a SearchView and a ListView. Specifically, the CreateView, the UpdateView and the DisplayView all invoke the model components mealDate, recordrestaurent, payer, participants, cost and averageAmount. The SearchView invokes the model component mealDate. The ListView invokes the model components recordrestaurent, payer, participants and cost.

Further, properties of the model-view elements are described. For example, in the CreateView invoking the model component mealDate, a two-column illustration pattern is defined, i.e., “columns=2”, and “rowbreak” is set for the second column. Besides, data format properties are expressed using “properties” in the NEL script. For example, all the model-view elements invoking the model component mealDate illustrate the model component mealDate in a format of “MM-dd-yy”.

Referring to FIG. 9, in S205: NEL analysis; and in S207: syntax validation. After the NEL script is edited, the NEL script is analyzed and subject to a syntax validation process.

FIG. 11 schematically illustrates a process 300 for implementing the above described NEL analysis and syntax check. As shown in FIG. 11, the NEL script may successively flow to a lexer analyzer NEL Lexer, a syntax analyzer NEL Parser, an object code linker Lazy Linker and a syntax validator NEL Validator, to have a lexer analysis process, a syntax analysis process, an annotation loading process and a syntax validation process performed thereto. Thereafter, a NEL model may be obtained. In some embodiment, the NEL script may skip the lexer analyzer and flow directly to the syntax analyzer.

If an error occurs in the process 300, an error reminder may be generated to remind the user, such that the user can adjust the NEL script.

Referring to FIG. 9, in S209: NEL object model formation. The NEL script which passes the syntax validation is transformed into a NEL object model, i.e., a model object configuration file, and the NEL object model may be stored in a NEL model repository. And in S211: human-machine interface configuration file formation. The NEL object model is transformed into a human-machine interface configuration file, including Java objects, ORM metadata, etc.

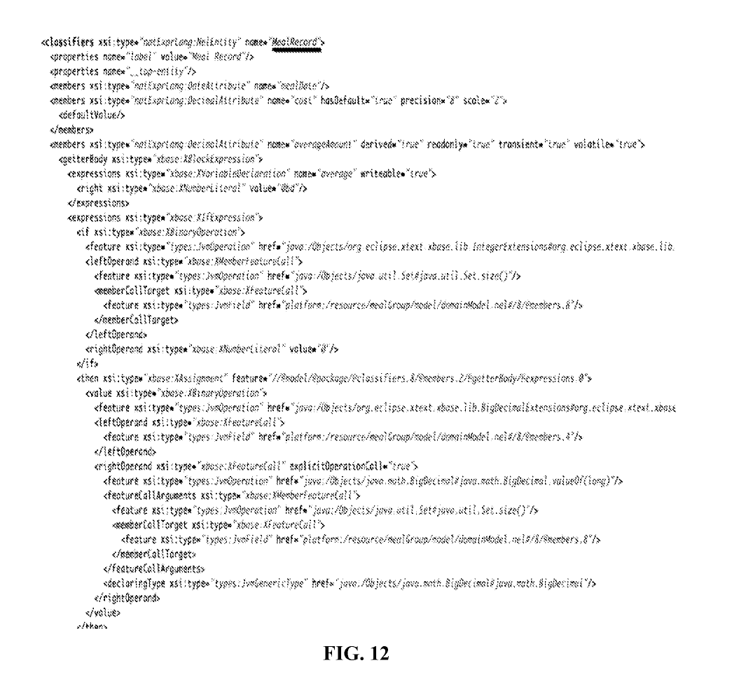

FIG. 12 schematically illustrates an example of a NEL object model configuration file formed in the process 200.

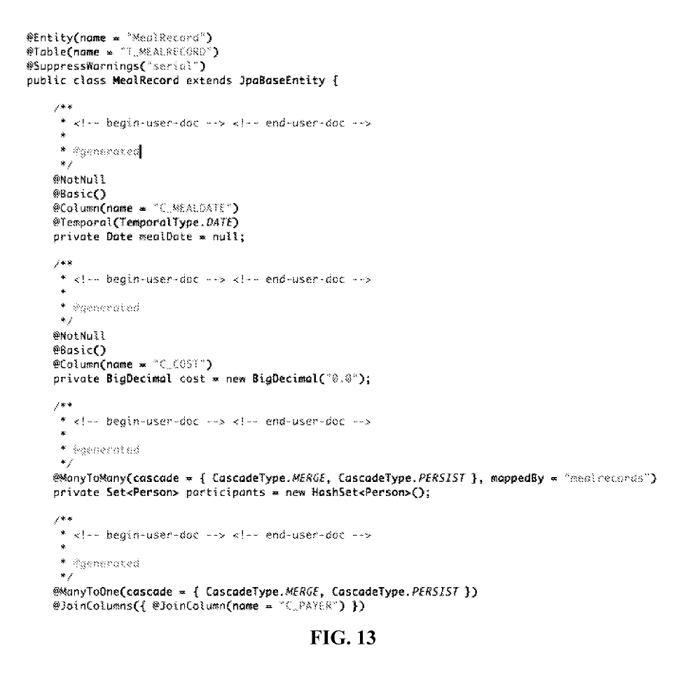

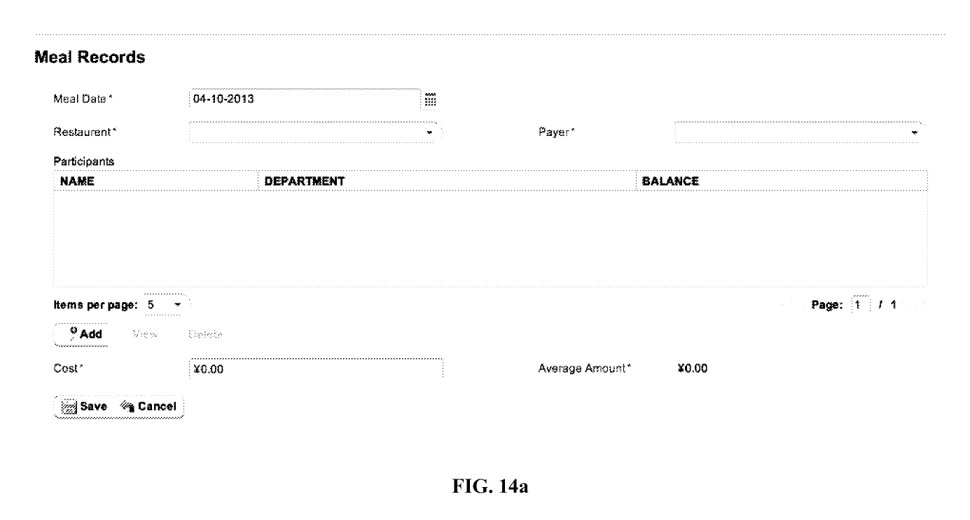

FIG. 13 schematically illustrates an example of a human-machine interface configuration file formed in the process 200.

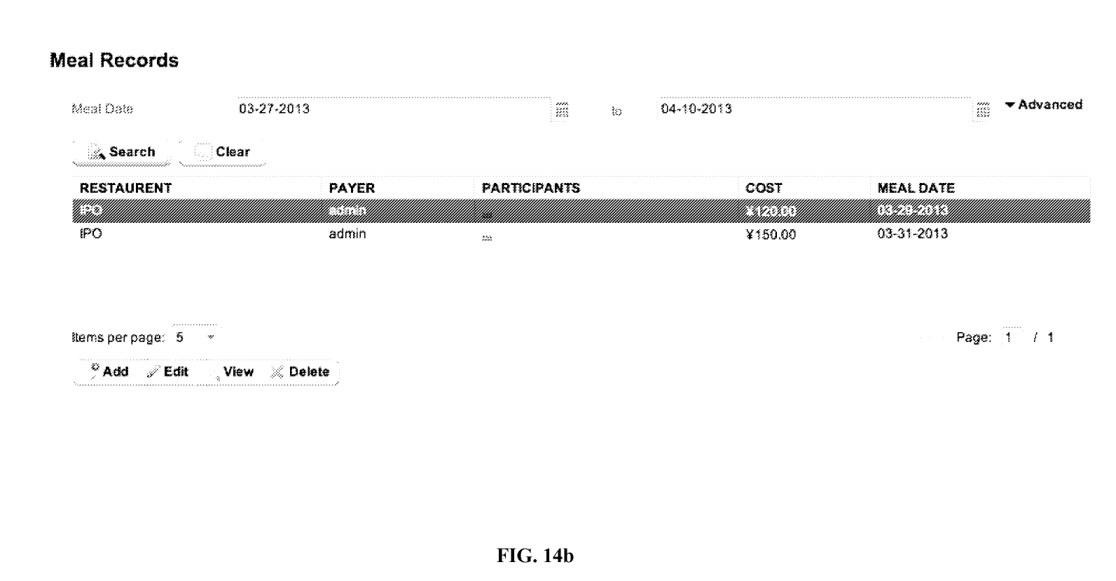

FIGS. 14a and 14b pages obtained by rendering the human-machine interface configuration file formed in the process 200.

FIG. 14a illustrates a visual effect of illustrating the CreateView in the human-machine interface, in which the model components mealDate, recordrestaurent, payer, participants, cost and averageAmount invoked by the CreateView are illustrated. The one-to-many aggregation relationship between the model component participants and other model components is illustrated using a data table.

FIG. 14b illustrates a visual effect of illustration the SearchView in the human-machine interface, in which an operation button Search is provided to implement search function using the model component mealDate as a key work. The model component mealDate is illustrated in the human-machine interface with a “MM-dd-yy” format.

Those skilled in the art may know that, parts or all of the present disclosure may be implemented based on a combination of software and a general hardware platform according to above description of embodiments. Therefore, embodiments of the present disclosure may be accomplished in a computer software product substantially. The computer software product may include at least one computer readable medium which has computer executable instructions stored therein. When the executable instructions are implemented by at least one device selected from a computer, a computer network and other electronic devices, the at least one device can implement operations according to embodiments of the present disclosure. The computer readable medium may include but not be limited to floppy disk, optical disk, Compact Disc-Read Only Memory (CD-ROM), magneto-optical disc, Read-Only Memory (ROM), Random-Access Memory (RAM), Erasable Programmable Read-Only Memory (EPROM), Electrically Erasable Programmable Read-only memory (EEPROM), magnetic card, optical card, flash or any other medium/computer readable medium which is adapted to store computer executable instructions.

Embodiments of the present disclosure may be implemented in a plurality of general or special computer system environment or devices, such as a personal computer (PC), a sever computer, a handheld device, a portable device, a pad, a multi-processor system, a system based on microprocessor, a set-top box, a programmable consumer electronic device, a network PC, a mini computer, a mainframe computer and a distributed computing environment containing any of the above systems or devices.

Embodiments of the present disclosure may be realized by a context including executable instructions which can be implemented by a computer, such as a program module. Generally, a program module includes routines, programs, objects, components and data structures which can implement particular tasks or realize particular abstract data categories. Embodiments of the present disclosure may be implemented in a distributed computing environment, where tasks may be implemented by remote processing devices which are coupled in a communication network. In the distributed computing environment, program modules may be located in local and remote computer storing mediums, such as a memory.

Those skilled in the art could understand that the above described components may be programmable logic devices, such as one or more selected from programmable array logic (PAL), generic array logic (GAL), field programmable gate array (FPGA), complex programmable logic device (CPLD), which may not be limited here.

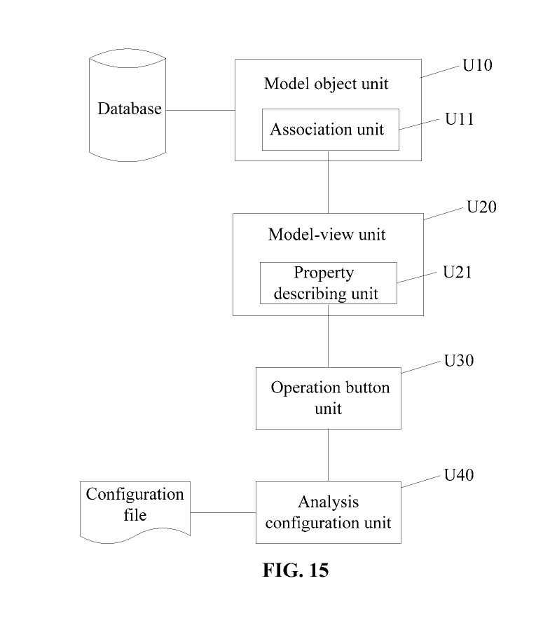

Embodiments of the present disclosure further provide a system for automatically forming a human-machine interface. FIG. 5 schematically illustrates a block diagram of a system for automatically forming a human-machine interface according to one embodiment of the present disclosure. As shown in FIG. 15, the system may include: a model object unit U10, a model-view unit U20, an operation button unit U30 and an analysis configuration unit U40.

The model object unit U10 may be adapted to define a model object based on contents to be illustrated in the human-machine interface. The model object may include at least one model component having mapping relationship with metadata in a database. In some embodiments, the model object unit U10 may further include: an association unit U11, adapted to define an association relationship between the model components, where a pattern for illustrating the model components in the human-machine interface may correspond to the association relationship.

The model-view unit U20, connected to the model object unit U10, may be adapted to establish a model-view corresponding to the defined model object. In some embodiments, the model-view may include at least one model-view element which has a mapping relationship with at least one model component. The model-view element may be used for generating at least one of a DisplayView, a CreateView, an UpdateView, a SearchView, a ListView and an ItemView. In some embodiments, the model-view unit U20 may further include: a property describing unit U21, adapted to expressing the property of the model-view element, where a pattern for illustrating the model-view element in the human-machine interface corresponds to the property.

The operation button unit U30, connected with the model-view unit U20, may be adapted to define an operation button. The operation button may correspond to a particular operation to the model component, which particular operation may correspond to the model-view element.

The analysis configuration unit U40, connected with the operation button unit U30, may be adapted to analyze the defined model object and the established model-view based on a predetermined syntax rule to form a model object configuration file and a human-machine interface configuration file. The model object configuration file may be adapted to provide mapping between the model object and the database. The human-machine interface configuration file may be adapted to illustrate the model object using a corresponding model-view. In some embodiments, the analysis configuration unit U40 may be further adapted to analyze the association relationship defined by the association unit U11, where the analyzed association may be represented in the human-machine interface configuration file. In some embodiments, the analysis configuration unit U40 may be further adapted to analyze the property expressed by the property describing unit U21, where the analyzed property may be represented in the human-machine interface configuration file. In some embodiments, the analysis configuration unit U40 may be further adapted to analyze the operation button defined by the operation button unit U30, where the relationship between the operation button and the model component and the model-view element may be represented in the human-machine interface configuration file.

The disclosure is disclosed, but not limited, by preferred embodiments as above. Based on the disclosure of the disclosure, those skilled in the art can make any variation and modification without departing from the scope of the disclosure. Therefore, any simple modification, variation and polishing based on the embodiments described herein is within the scope of the present disclosure.

What is claimed is:

1. A method for automatically forming a human-machine interface, comprising:
defining a model object based on contents to be illustrated in the human-machine interface, where the model object comprises at least one model component have a one-to-one mapping relationship with metadata in a database;
establishing a model-view corresponding to the defined model object, where the model-view comprises at least one model-view element each of which having a mapping relationship with one of the at least one model component; and
analyzing the defined model object and the established model-view based on a predetermined syntax rule to form a model object configuration file and a human-machine interface configuration file, where the model object configuration file is adapted to provide mapping between the defined model object and the database, and the human-machine interface configuration file is adapted to illustrate the model object using the corresponding model-view.

2. The method according to claim 1, wherein the model-view element comprises at least one of a model-view element for displaying, a model-view element for creating, a model-view element for updating, a model-view element for searching, a model-view element for listing and a model-view element for item illustration.

3. The method according to claim 1, wherein defining the model object further comprises:
defining an association relationship between model components, where an illustration pattern of the human-machine interface for illustrating the defined model object in the human-machine interface corresponds to the defined association relationship, and the association relationship is represented in the human-machine configuration file after analysis.

4. The method according to claim 3, wherein the association relationship between model components comprises at least one of an aggregation relationship, a composition relationship and a multiplicity relationship.

5. The method according to claim 3, wherein the illustration pattern of the human-machine interface comprises at least one of link, pull-down list, data table, embedded form and form.

6. The method according to claim 1, further comprising:
defining an operation button corresponding to a particular operation to a model component, where the particular operation corresponds to the model-view element; and
analyzing the operation button and representing, in the human-machine interface configuration file, relationship between the operation button and the model component and the model-view element.

7. The method according to claim 6, wherein the particular operation comprises one or more of display, create, update, delete and search.

8. The method according to claim 1, wherein establishing the model-view corresponding to the defined model object further comprises:
describing a property of the model-view element, where an illustration pattern for illustrating the model-view element in the human-machine interface corresponds to the property, and the property is represented in the human-machine interface configuration file after the analysis.

9. The method according to claim 8, wherein the property comprises one or more of button layout, button grouping, group embedding, button pattern, read-only, data format and event expression format.

10. The method according to claim 1, wherein defining the model object and establishing the model-view corresponding to the defined model object are implemented using a natural expression language script.

11. The method according to claim 10, further comprising:
before defining the model object and establishing the model-view corresponding to the defined model object, determining a syntax rule of the natural expression language, where the predetermined syntax rule comprises the syntax rule of the natural expression language.

12. The method according to claim 1, wherein the human-machine interface configuration file comprises at least one kind of JAVA class codes, object relational mapping file and JAVA document.

13. A system for automatically forming a human-machine interface, comprising:
a model object unit, adapted to define a model object based on contents to be illustrated in the human-machine interface, where the model object comprises at least one model component have a one-to-one mapping relationship with metadata in a database;
a model-view unit, adapted to establish a model-view corresponding to the defined model object, where the model-view comprises at least one model-view element each of which having a mapping relationship with one of the at least one model component; and
an analysis configuration unit, adapted to analyze the defined model object and the established model-view based on a predetermined syntax rule to form a model object configuration file and a human-machine interface configuration file, where the model object configuration file is adapted to provide mapping between the defined model object and the database, and the human-machine interface configuration file is adapted to illustrate the model object using the corresponding model-view.

14. The system according to claim 13, wherein the model-view element comprises at least one of a model-view element for displaying, a model-view element for creating, a model-view element for updating, a model-view element for searching, a model-view element for listing and a model-view element for item illustration.

15. The system according to claim 13, wherein the model object unit further comprises:
an association unit, adapted to define an association relationship between model components, where an illustration pattern of the human-machine interface for illustrating the defined model object in the human-machine interface corresponds to the defined association relationship,
where the analysis configuration unit is further adapted to analyze the association relationship, and the association relationship is represented in the human-machine configuration file after the analysis.

16. The system according to claim 13, further comprising:
an operation button unit, adapted to define an operation button corresponding to a particular operation to a model component, where the particular operation corresponds to the model-view element,
where the analysis configuration unit is further adapted to analyze the operation button and represent, in the human-machine interface configuration file, relationship between the operation button and the model component and the model-view element.

17. The system according to claim 13, wherein the model-view unit further comprises:
a property describing unit, adapted to describe a property of the model-view element, where an illustration pattern for illustrating the model-view element in the human-machine interface corresponds to the property,
where the analysis configuration unit is further adapted to analyze the property and the property is represented in the human-machine interface configuration file after the analysis.
